(19) United States
(12) Patent Application Publication
(10) Pub. No.: US 2017/0242792 A1
(43) Pub. Date: Aug. 24, 2017

(54) STORAGE DEVICE THAT CARRIES OUT A READ CACHE OPERATION

(71) Applicant: KABUSHIKI KAISHA TOSHIBA, Tokyo (JP)

(72) Inventor: Kazunari MATSUMOTO, Fujisawa Kanagawa (JP)

(21) Appl. No.: 15/233,900

(22) Filed: Aug. 10, 2016

(30) Foreign Application Priority Data
Feb. 23, 2016 (JP) 2016-031993

(51) Int. Cl. G06F 12/0802; G06F 3/06; G06F 12/1009

(52) U.S. Cl. CPC G06F 12/0802; G06F 12/1009; G06F 3/0611; G06F 3/0656; G06F 3/0685; G06F 2212/60

(57) ABSTRACT

A storage device includes a disk including a plurality of tracks, each track including a plurality of addressable blocks of data, a buffer memory, and a controller that stores in the buffer memory, in response to a command to read a first value of a first key, the first value, and also a second value of a second key upon determining that the second value is entirely readable after the first value is read, from the same track as the first value.

### CROSS-REFERENCE TO RELATED APPLICATION

This application is based upon and claims the benefit of priority from Japanese Patent Application No. 2016-031993, filed Feb. 23, 2016, the entire contents of which are incorporated herein by reference.

### FIELD

Embodiments described herein relate generally to a storage device, in particular a storage device that carried out a read cache operation.

### BACKGROUND

A storage device that stores a key and a value corresponding to the key in a storage medium is known.

### DESCRIPTION OF THE DRAWINGS

FIG. 1 is a block diagram illustrating a storage system according to a first embodiment.

FIG. 2 is a table explaining a value and a key stored in a storage medium.

FIG. 3 illustrates a management table illustrated in FIG. 1.

FIG. 4 illustrates details of key management information illustrated in FIG. 1.

FIG. 5 is a flowchart illustrating a read (read cache) process of the storage system according to the first embodiment.

FIG. 6 illustrates a disk and a head located thereon to explain the read (read cache) process of the storage system according to the first embodiment.

FIG. 7 illustrates a memory space of a buffer memory after the read process.

FIG. 8 illustrates the memory space of the buffer memory after the read cache process.

FIG. 9 illustrates a disk and a head located thereon to explain a read cache process of a storage system according to a comparative example.

FIG. 10 is a flowchart illustrating a read (read cache) process of a storage system according to a first modification example.

FIG. 11 illustrates a disk and a head located thereon to explain the read (read cache) process of the storage system according to the first modification example.

FIG. 12 illustrates the memory space of the buffer memory after a first read cache process and a read process.

FIG. 13 illustrates the memory space of the buffer memory after a second read cache process.

FIG. 14 is a block diagram illustrating a storage system according to a second embodiment.

FIG. 15 is a block diagram illustrating a storage system according to a third embodiment.

FIG. 16 illustrates a PUT (write) operation carried out in the storage system according to the third embodiment.

FIG. 17 illustrates a GET (read) operation carried out in the storage system according to the third embodiment.

### DETAILED DESCRIPTION

Embodiments described herein provide a storage and a storage system capable of efficiently performing a read cache process.

In general, according to an embodiment, a storage device includes a disk including a plurality of tracks, each track including a plurality of addressable blocks of data, a buffer memory, and a controller that stores in the buffer memory, in response to a command to read a first value of a first key, the first value, and also a second value of a second key upon determining that the second value is entirely readable after the first value is read, from the same track as the first value.

Hereinafter, embodiments will be described with reference to the accompanying drawings. In this description, the common reference numerals are used for the common parts in the drawings.

### First Embodiment

### 1. Configuration

### 1-1. Storage System

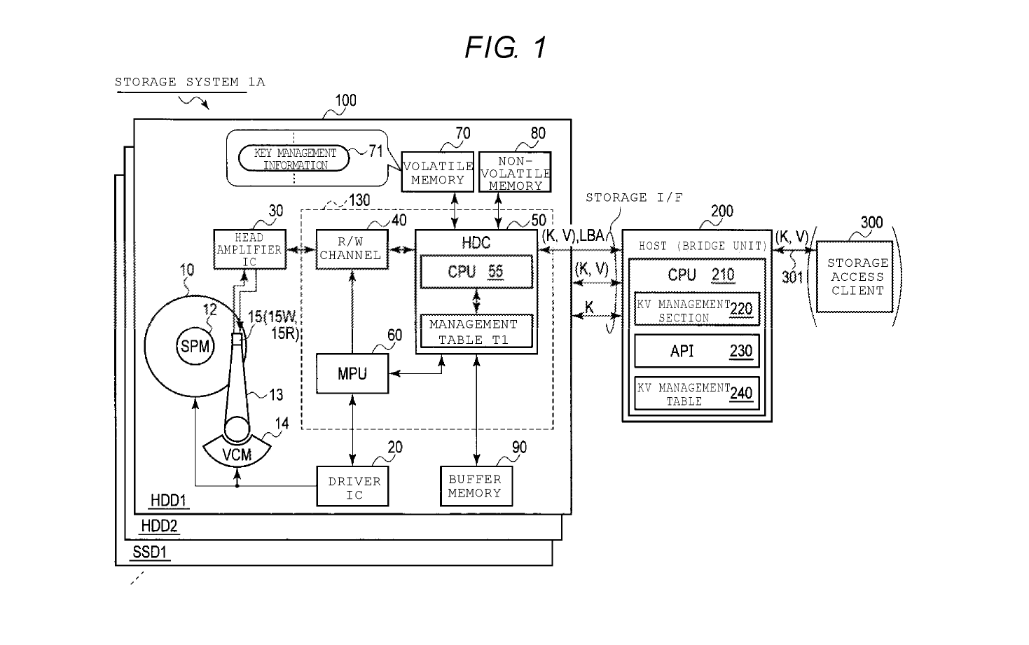

A storage system 1A according to a first embodiment will be described with reference to FIG. 1. The storage system 1A includes a magnetic disk 10 serving as a storage medium, and is configured to allow an external storage access client (hereinafter, referred to as “client”) 300 to access using an application programming interface (API) 230 via a network 301 such as internet protocol (IP). Here, the API refers to an interface that defines a procedure, a data format, and the like, which expose a program function or the like of a certain processor (here, CPU 210) for use by an external processor (here, client 300). For example, the client 300 can transmit a read request to the storage system 1A using the API 230 in accordance with a predetermined procedure that is defined (for example, a designation of a command for using a general-purpose read function of the CPU 210). The storage system. 1A that receives the read request returns read data in response to the read request from the client 300. As described above, the client 300 uses a general-purpose function performed by the CPU 210 in accordance with the predetermined procedure which is defined in the API 230, thereby using the function. Accordingly, it is unnecessary that the client 300 creates complex programs or the like for using the general-purpose function from the beginning. Therefore, when the client 300 knows a simple instruction for using the general-purpose function such as the read request, the client 300 can access the storage system 1A.

The storage system 1A stores a key K and a value V corresponding to the key K in the magnetic disk 10.

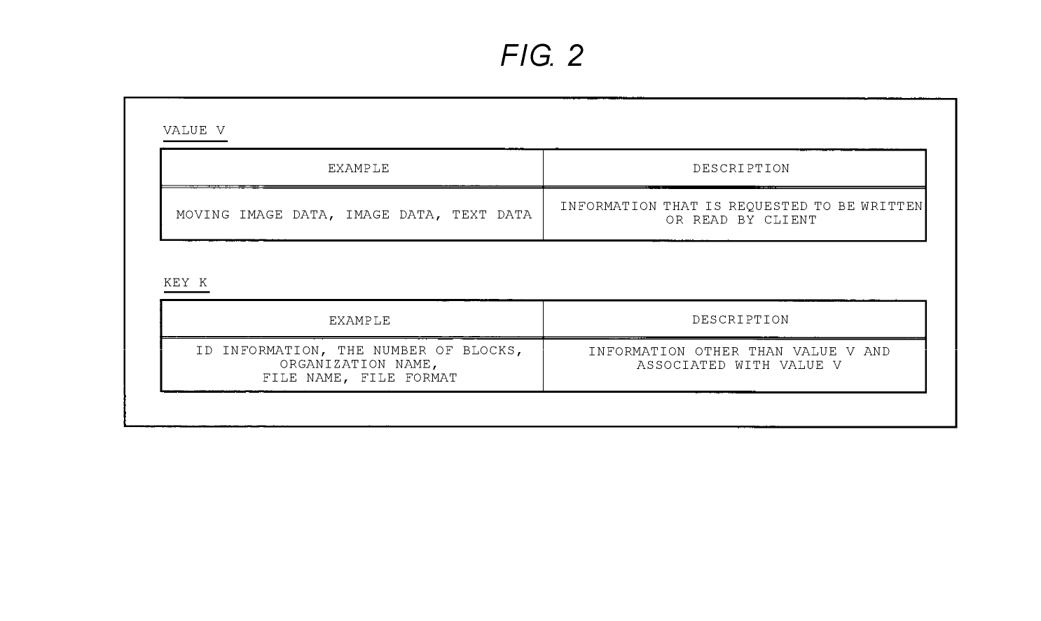

As illustrated in FIG. 2, the value V is information that is subjected to a write request from the client 300 or target information of a read request from the client 300. As an example, the value V is user data such as video data, image data, or text data transmitted from the client 300 or requested by the client 300.

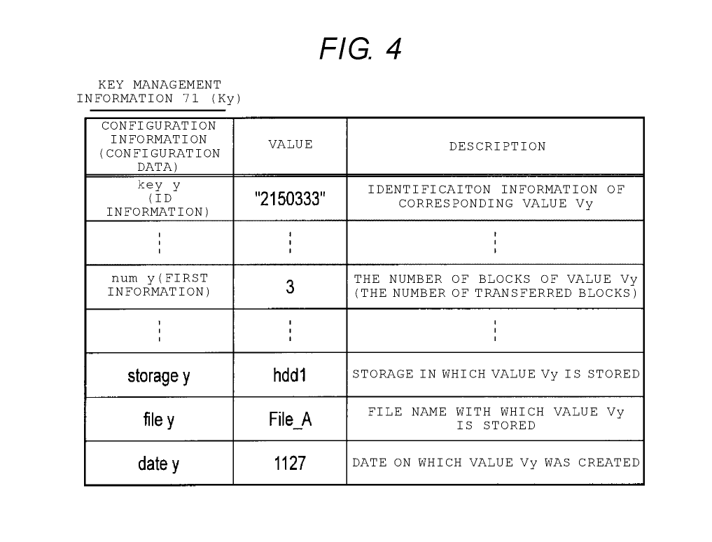

As illustrated in FIG. 2, the key K is information other than the value V and is associated with the value V. As an example, the key K includes ID information, the number of blocks, an organization name, a file name, a file format, or the like of the associated value V. The ID information is unique identification information of the corresponding value V. The number of blocks is information indicating the number of blocks that configure the value V. The organization name is, for example, HDD1 or the like in which the value V is stored. The file name is, for example, File_A or the like. The ID information is, for example, 2150333 or the like. The number of the blocks is, for example, 1 or the like. The file format is, for example, a text file format, an image file format, a video file format, an audio file format, or the like. The information configuring the key K (configuration information) is not limited thereto. Details of the configuration information will be described below with reference to FIG. 4.

In the storage system (KV-type storage system) 1A described above, the key K of random size serving as identification information and the value V of random size corresponding to the key K are stored in a storage 100. According to the above configuration, when the client 300 designates the key K, it is possible to carry out operations to PUT (write), GET (read), or DELETE (erase) the value V corresponding to the key K. Details of these operations will be described below.

Returning to FIG. 1, the storage system 1A includes a host 200 that receives a request from the external client 300, and a plurality of storages 100 that is managed by the host 200.

When the host 200 is seen in the entire computer system including the storage system 1A and the client 300, the host 200 is abridge unit that serves as a bridge such that the client 300 and the plurality of storages 100 can communicate with each other. The host 200 is, for example, a server, a personal computer, an interface device, or the like. Here, the host 200 operates such that the client 300 and the storage 100 can communicate with each other. In the first embodiment, the host 200 controls the plurality of storages 100, and responds to the request from the client 300. Applications or the like included in the host 200 can access each of the storages 100 using the API 230.

The host 200 issues a predetermined command such as a read command in response to the request from the client 300, and controls each of the storages 100 via a storage I/F. The host 200 includes a central processing unit (CPU) 210 that controls operations of the entire storage system 1A (for example, read, write, or the like). The CPU 210 includes a KV management section 220, an API 230, and a KV management table 240.

The KV management section 220 processes instructions from the client 300. More specifically, the KV management section 220 stores the key K in a SSD1 based on a pair of the key and the value (K, V) that has been received from the client 300, designates a logical block address (LBA) indicating the position of the value V, and stores the value V and the key K in a HDD1 or a HDD2. Thus, the KV management section 220 refers to the KV management table 240 that indicates a corresponding relation among the key K, the value V corresponding to the key K, and the LBA designated by the host 200, as necessary.

The KV management table 240 stores a corresponding relation between all of the keys K and the values V that are transmitted from the client 300 and written in each of the storages 100, and the LBA designated by the host 200. The contents of the KV management table 240 is updated as necessary, for example, when a new key K and a new value V are stored in the disk 10 of a new LBA through a write operation.

In the first embodiment, the HDD1, which includes the magnetic disk (hereinafter, referred to as “disk”) 10 serving as a storage medium, will be described as an example of the storage 100.

The HDD1 includes a head-disk assembly (HDA), a driver IC 20, a head amplifier integrated circuit (hereinafter, referred to as “head amplifier IC”) 30, a volatile memory 70, a non-volatile memory 80, a buffer memory (cache memory) 90, and a system controller 130 configured with a one-chip integrated circuit. The HDD1 is connected to the host 200 via a SATA I/F, a SAS I/F, or the like serving as a storage I/F. The HDD1 writes write data V transferred from the host 200 in the disk 10, and transfers read data V read from the disk 10 to the host 200.

The HDA includes the disk 10, a spindle motor (SPM) 12, an arm 13 to which a head 15 is mounted, and a voice coil motor (VCM) 14. The disk 10 rotates by being driven by the spindle motor 12. The arm 13 and the VCM 14 configure an actuator. The actuator moves the head 15 that is mounted to the arm 13 to a predetermined position on the disk 10 by the driving of the VCM 14. The number of the disks 10 and the number of the heads 15 may be two or more.

The head 15 includes a write head 15W and a read head 15R that are provided at the tip of the head 15. The write head 15W generates magnetic fields in a direction perpendicular to the surface of the disk 10, and writes the write data on a track of the surface of the disk 10. The read head 15R reads data recorded on the track of the disk 10.

The driver IC 20 controls the driving of the SPM 12 and the driving of the VCM 14 in accordance with the control of the system controller 130 (more specifically, an MPU 60 described below).

The head amplifier IC 30 includes a read amplifier and a write driver. The read amplifier amplifies a read signal read by the read head 15R, and transfers the amplified read signal to a read/write (R/W) channel 40. The write driver transfers a write current corresponding to the write data output from the R/W channel 40, to the write head 15W.

The volatile memory 70 is a semiconductor memory that loses data stored therein when the power supply is cut off. The volatile memory 70 stores necessary data or the like during processes and calculations by each section of the storage system 1A. For example, key management information 71 that is used to manage configuration information (configuration parameters) of each key K is developed in the volatile memory 70 during a read cache process described below. The volatile memory 70 is, for example, a synchronous dynamic random access memory (SDRAM) or the like.

The non-volatile memory 80 is a semiconductor memory that maintains data stored therein even when the power supply is cut off. The non-volatile memory 80 is, for example, a flash read only memory (FROM) or the like.

The buffer memory 90 is a semiconductor memory that temporarily stores the read data V or the like transferred between the disk 10 and the host 200. The buffer memory 90 may be integrally arranged with the volatile memory 70. The buffer memory 90 is, for example, a dynamic random access memory (DRAM), a static random access memory (SRAM), a SDRAM, a ferroelectric random access memory (FeRAM), and a magnetoresistive random access memory (MRAM) or the like.

The system controller (memory controller) 130 is achieved, for example, using a large scale integrated circuit (LSI) referred to as a system-on-a-chip (SoC) in which a plurality of elements is integrated into a single chip. The system controller 130 includes the read/write (R/W) channel 40, a hard disk controller (HDC) 50, and a microprocessor (MPU) 60.

The R/W channel 40 performs a signal process of the read data and a signal process of the write data. The R/W channel 40 has a circuit or a function of measuring the signal quality of the read data.

The HDC 50 controls data transfer between the host 200 and the R/W channel 40 in accordance with an instruction from the MPU 60. The HDC 50 includes a CPU 55 and a table T1.

The CPU 55 controls operations of the entire the HDC 50 (i.e., the entire storage (HDD1) 100 controlled by the HDC 50, except for the host 200). The table T1 is a management table (conversion table) indicating a corresponding relationship among the key K, the value V, and the LBA. Details of the table T1 will be described below.

The MPU 60 is a main controller that controls each section of the HDD1 and controls operations of the HDD1. The MPU 60 controls the VCM 14 via the driver IC 20, and executes a servo control of positioning the head 15, for example.

The configuration of the HDD2 is similar to that of the HDD1. The configurations of the host 200 and the HDD1 are not limited thereto. For example, the configurations of the host 200 and the HDD1 are not limited to a table format such as the KV management table 240 or the table T1, and may be a predetermined function or formula format, a predetermined mapping format, or the like. The positions at which the host 200 and the HDD1 are arranged are not limited.

The SSD1 includes a flash memory such as a NAND-type flash memory serving as a storage medium. The flash memory includes memory cell arrays in which a plurality of memory cells is arranged at intersections between word lines and bit lines. Each of the memory cells includes a control gate and a floating gate. By controlling the voltage of the control gate connected to the word lines, presence or absence of electrons injected into the floating gate is controlled, and thus the data are written in a non-volatile manner. Detailed description of the other configuration of the SSD1 will not be repeated.

### 1-2. Table T1

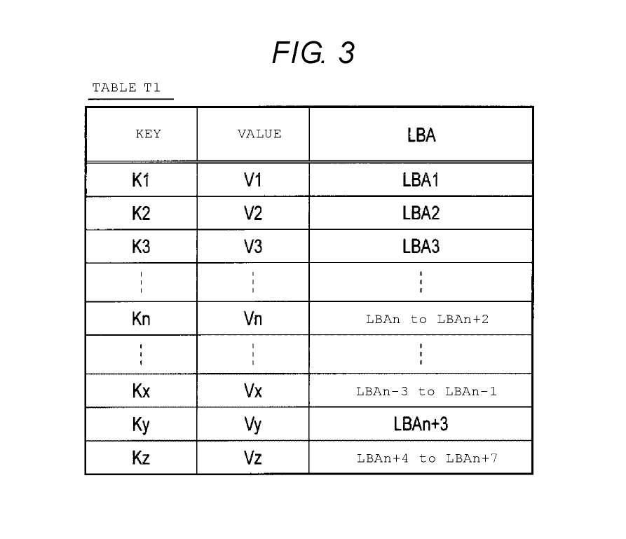

FIG. 3 illustrates the table T1 illustrated in FIG. 1. As illustrated in FIG. 3, the table T1 is a management table indicating the corresponding relationship among the value V that is written on disk 10 of the storage 100, the key K corresponding to the value V, and the LBA designated by the host (position information of a unit (block/sector) in which the value V is written).

The table T1 shows that a key K1, a value V1, and a LBA1 are associated with each other, for example. Similarly to this, a key K2, a value V2, and a LBA2 are associated with each other. A key K3, a value V3, and a LBA3 are associated with each other. A key Kn, a value Vn, and LBAn to LBAn+2 are associated with each other. A key Kx, a value Vx, and LBAn−3 to LBAn−1 are associated with each other. A key Ky, a value Vy, and a LBAn+3 are associated with each other. A key Kz, a value Vz, and LBAn+4 to LBAn+7 are associated with each other.

As described above, in the storage system 1A, the value V of random size corresponding to the key K is stored in the disk 10. Therefore, the LBA corresponding to the value V is arbitrary, and is not necessarily one block. For example, the three LBAn to LBAn+2 (3 blocks) correspond to the value Vn. The one LBAn+3 (1 block) corresponds to the value Vy.

As described in FIG. 2, each key K includes not only the ID information of the value V corresponding thereto, but also other configuration information such as a date associated with the corresponding value V.

### 1-3. Key Management Information

FIG. 4 illustrates the key management information 71 illustrated in FIG. 1. In FIG. 4, the key management information 71 of the key Ky is illustrated as an example. The key Ky includes the following configuration information (configuration data, configuration parameter), for example. Here, the “configuration information” illustrated in FIG. 4 is information that configures the key Ky and associated with the value Vy corresponding to the key Ky as described above.

As illustrated in FIG. 4, a key y (ID information) has a value of, for example, “2150333”, and is unique information for specifying the corresponding value Vy. A num y (first information) has a value of, for example, “1”, and indicates the number of blocks of the value Vy. More specifically, the num y is information that indicates the number of units which configure the write data transferred from the host 200 (the number of blocks/the number of sectors) as the value Vy. In other words, the num y corresponds to the size of the value Vy. A storage y (organization name) has a value of, for example, “hdd1”, and indicates the storage in which the value Vy is stored (here, HDD1). A file y (file name) has a value of, for example, “File A”, and indicates the file name with which the value Vy is stored. A date y (date) has a value of, for example, “1127”, and indicates November 27 on which the value Vy was created.

The configuration information illustrated in FIG. 4 is merely an example, and is not limited thereto. For example, the configuration information may include other attribute data of the value V such as the size, the title, or the annotation of the value V.

### 2. Operation

### 2-1. Read (Read Cache) Process

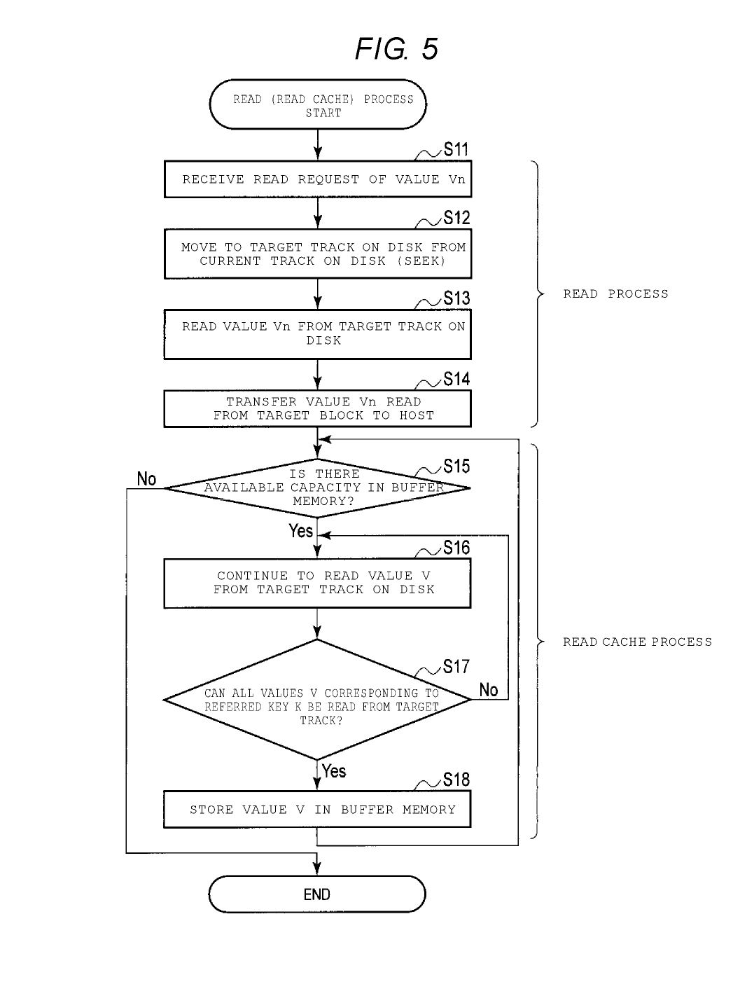

The read (read cache) process of the storage system 1A will be described with reference to FIGS. 5 to 7. In the first embodiment, as an example, the host 200 receives a read request to read the value Vn (LBAn to LBAn+2 indicated by the LBA (the number of configuration blocks: 3)), which is the read data, from the client 300. Hereinafter, the read process relating to the read request will be described.

### Read Process

In Step S11 illustrated in FIG. 5, the host 200 receives a read request designating the key Kn from the client 300 via the API 230. The KV management section 220 of the host 200 that receives the read request refers to the KV management table 240, and searches for the storage 100 in which the key Kn corresponding to the value Vn is stored, based on the corresponding relationship between the key Kn and the value Vn indicated in the KV management table 240. As a result of the searching, when it is determined that the storage in which the key Kn is stored is the HDD1, the KV management section 220 refers to the KV management table 240, designates the LBAn to LBAn+2 corresponding to the key Kn in the KV management table 240, to read the value Vn as the read data.

When searching for the key Kn, the KV management section 220 may search the SSD1. Details of this will be described below.

In Step S12, the CPU 55 of the storage 100 to which the LBAn to LBAn+2 are designated moves the position of the read head 15R on the disk 10, from the current track to the target track in which the value Vn is stored (seek) . More specifically, as illustrated in FIG. 3, the CPU 55 refers to the table T1 that indicates a corresponding relationship between the value Vn and the LBAn to LBAn+2, and moves the position of the read head 15R to the target track based on the referred corresponding relationship (Vn, LBAn to LBAn+2).

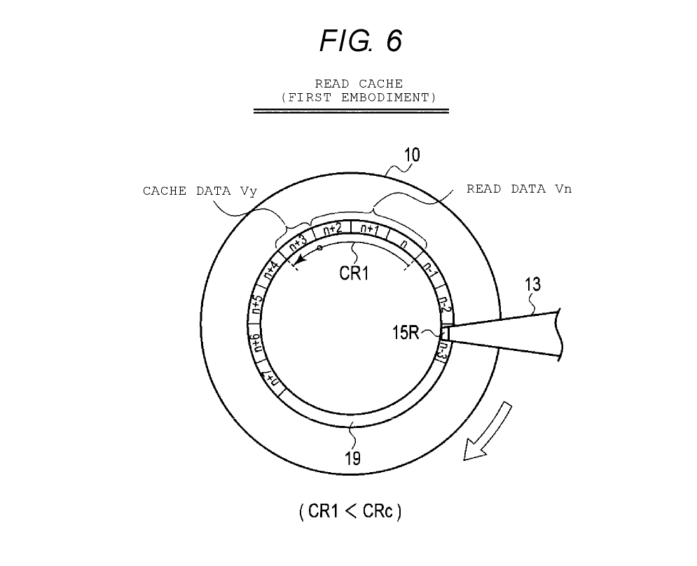

In Step S13, after the seek is completed, the HDD1 reads the value Vn from the target track of the disk 10. For example, as illustrated in FIG. 6, the MPU 60 of the HDD1 reads the value Vn corresponding to the LBAn to LBAn+2 that are obtained by referring to the table T1, from the target track 19 of the disk 10 by using the read head 15R. More specifically, by the rotation of the disk 10 illustrated by the arrow in FIG. 6, when the position of the read head 15R reaches the position of the value Vn (LBAn to LBAn+2), the value Vn is read by the read head 15R. The value Vn read from the disk 10 is stored in the buffer memory 90.

Returning to FIG. 5, in Step S14, the HDD1 responds to the read request by transferring the value Vn to the host 200. More specifically, the CPU 55 of the HDD1 transfers the value Vn to the host 200 from the buffer memory 90.

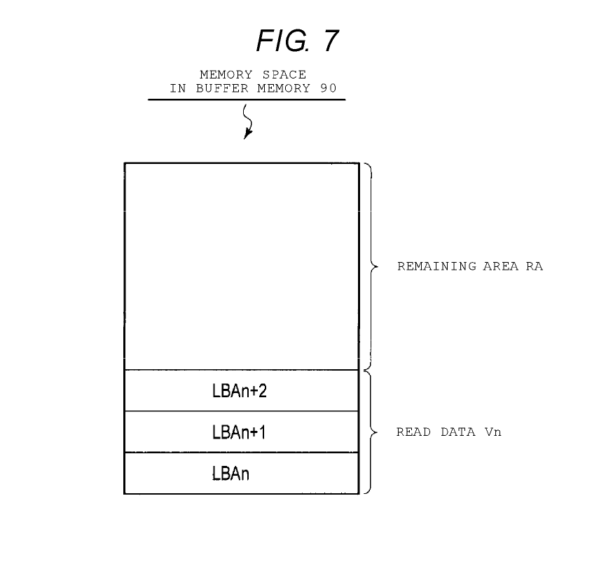

As illustrated in FIG. 7, as a result of the read process, the value Vn is stored in a memory space of the buffer memory 90. As illustrated in FIG. 7, the area of the buffer memory 90 excluding the area storing the value Vn becomes a remaining area RA.

### Read Cache Process

Subsequently, the read cache process will be described. The read cache process is carried out considering the fact that an area subsequent to the area from which the read data were read (here, the value Vn) or an area in the vicinity of the subsequent area tends to be read in the near future. In the read cache process, for example, after a certain area (here, the LBAn to LBAn+2) is subjected to the read request, data stored in the following area that is subsequent to the certain area (here, the LBAn+3) is read also, and the data read from the following area is stored in advance in the buffer memory 90. By performing the read cache process as described above, when the data stored in advance in the buffer memory 90 is then subjected to the read request, it is possible to directly transfer the data relating to the read request from the buffer memory 90, without reading from the disk 10. As a result, it is possible to perform a high-speed read access of the storage system 1A.

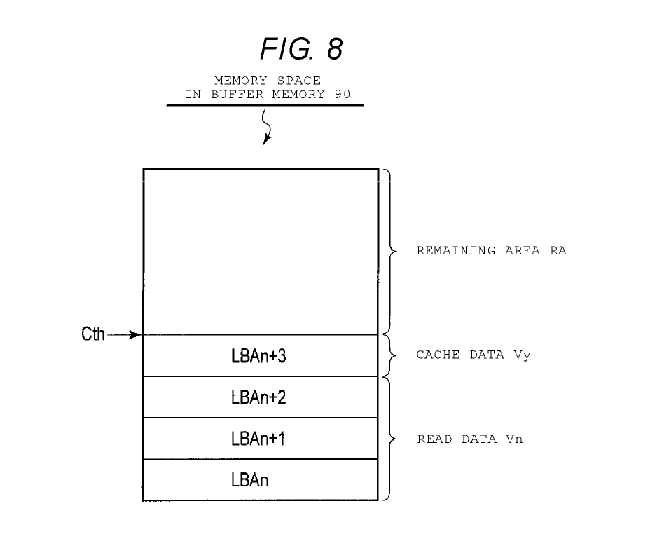

In Step S15, the HDD1 determines whether or not there is an available area for storing data read during the read cache process in the buffer memory 90. In this case, when it is determined that the capacity of the remaining area RA of the buffer memory 90 is less than a predetermined threshold value Cth (No in S15), due to, for example, the read data stored in the buffer memory 90, the CPU 55 of the HDD1 does not perform or terminates the read cache process. Here, the predetermined threshold value Cth refers to the ratio of empty area for using the buffer memory 90 (remaining area) to the entire memory area of the buffer memory 90. For example, in the case illustrated in FIG. 8, the threshold value Cth refers to the ratio of the remaining area RA to the entire memory area of the buffer memory 90 (areas in which the read data Vn and the cache data Vy are stored, and the remaining area RA). In this case, the threshold value Cth is, for example, approximately from 10% to 20%.

In the Step S16, when the condition of Step S15 is satisfied (Yes in S15), the HDD1 continues to read a value from the target track 19 of the disk 10 in the same manner.

In Step S17, the HDD1 refers to the key K corresponding to the value V read in S16 (or the LBA corresponding thereto), and determines whether or not all values V corresponding to the key K have been stored in the buffer memory 90. In other words, at this time, the HDD1 determines incomplete data, unused data, or the like by referring to the key K.

More specifically, the CPU 55 of the HDD1 refers to the key management information 71 (FIG. 4) developed in the volatile memory 70, and determines whether or not all values V corresponding to the key K have been stored in the buffer memory 90 based on information (first information) num indicating the number of blocks of the value V among each configuration data which configures the key K. When the condition of Step S17 is not satisfied (No in S17), the HDD1 repeats the process in Step S17.

In this case, for example, when the read cache process is started from the position (the middle of the LBAn−3) illustrated in FIG. 6, the CPU 55 refers to the key management information 71, and determines that all of the value Vx (LBAn−3 to LBAn−1) cannot be read, based on information (first information) num x indicating that the number of blocks of the value Vx corresponding to the key Kx is “3” (No in S17). This is because while the number of blocks indicated by the information num x is three blocks, the number of blocks of the value Vx which can be read is 2 blocks (LBAn−2 and LBAn−1), and thus the referred number and the read number do not match. Therefore, the CPU 55 determines that all of data which configures the value Vx cannot be read.

When the read head 15R illustrated in FIG. 6 reaches the position LBAn+3, the CPU 55 refers to the key management information 71 illustrated in FIG. 4, and determines that all of the value Vy (LBAn+3) can be read (available as cache data), based on information (first information) num y indicating that the number of blocks of the value Vv corresponding to the key Ky is “1” (Yes in S17). This is because information num y indicating the number of blocks is one block, and the block that configures the value Vy that can be read is also one block. Therefore, the number “1” of the configuration blocks indicated by the information num y, and the number “1” of the blocks that configure the value Vy which is read match. Accordingly, the CPU 55 determines that all of data of the value Vy which is read can be read and the read data can be stored in the buffer memory 90.

As illustrated in FIG. 8, in this case, when more data are stored in the buffer memory 90, since the cache data Vy and the read data Vn are stored in the buffer memory 90, the capacity of the remaining area RA of the buffer memory 90 would become less than the predetermined threshold value Cth.

Therefore, when the read head 15R illustrated in FIG. 6 reaches the position LBAn+4, the CPU 55 refers to the key management information 71, and determines that all of the value Vz (LBAn+3 to LBAn+7) cannot be stored in the buffer memory 90 (not available as cache data) , based on information (first information) num z indicating that the number of blocks of the value Vz corresponding to the key Kz is “4” (No in S15).

In Step S18, when the condition of Step S17 is satisfied (Yes in S17), the value V is stored in the buffer memory 90, and the process returns to S15. If there is no more space to store cache data in the buffer memory 90 (No in S15), the cache read process ends. As a result, for example, as illustrated in FIG. 8, the value Vy satisfying the condition of Step S17 (LBAn+3) can be stored in the buffer memory 90 as the cache data.

A read and read cache process of HDD2 or the like serving as another storage 100 is substantially similar to that of the HDD1. Therefore, detailed description thereof is not repeated.

### 3. Advantage

As described above, according to the configuration and operation of the storage system 1A according to the first embodiment, advantage of at least the following (1) and (2) are obtained.

(1) It is possible to efficiently perform the read cache Process.

After the read process is performed (S11 to S14 in FIG. 5), the CPU 55 of the HDD1 refers to the key K of the value V which is subjected to the cache read, and determines whether or not all of the value V indicated by the referred key K can be read (S17 in FIG. 5). In other words, by referring to the configuration data of the key K, the HDD1 determines whether or not the value that is going to be read would be incomplete data or unused data that do not include all data corresponding to the key K. More specifically, the CPU 55 refers to the key management information 71 (FIG. 4) developed in the volatile memory 70, and determines whether or not the information (first information) indicating the number of blocks of the value V corresponding to the key K matches the number of blocks of the value V that can be read thereafter.

When the condition of Step S17 is satisfied (Yes in S17), the value V is stored in the buffer memory 90. As a result, for example, as illustrated in FIG. 8, the value Vy satisfying the condition of Step S17 (LBAn+3) can be stored in the buffer memory 90 as the cache data.

Therefore, it is possible to prevent storing incomplete data (here, the value Vx or the like) or unused data as the cache data. Accordingly, there is no need to prepare a cache area of the buffer memory 90 for useless data such as incomplete data, a fragment of unnecessary data, or the like. More specifically, as illustrated in FIG. 3, the value Vx is configured with three pieces of data corresponding to the three LBA (LBAn−3 to LBA−1). Therefore, when only a piece of data of the value Vx can be read, or only two pieces of data of the value Vx can be read, the data are incomplete data that do not include all data of the value Vx. Thus, the data are useless data that is unnecessary to store in the buffer memory 90. As described above, according to the first embodiment, there is no need to store the useless data in the buffer memory 90. Thus, for example, improvement in the hit rate in the limited cache capacity of the buffer memory 90 can be expected, thereby efficiently performing the read cache process.

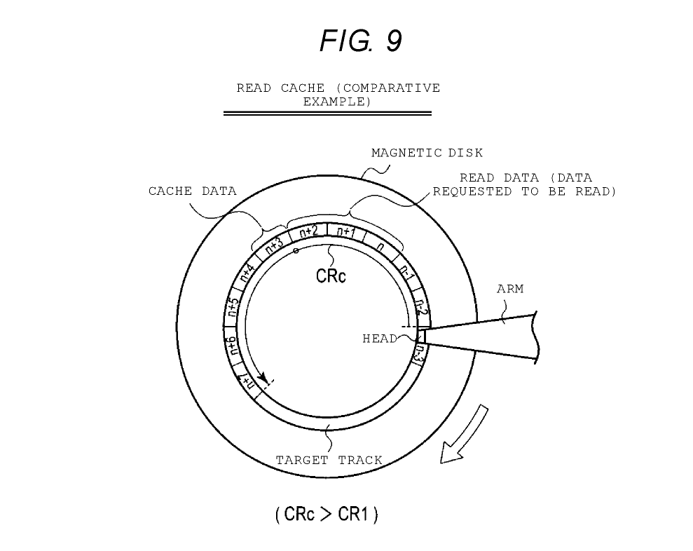

A comparative example illustrated in FIG. 9 shows command management in a sector/block unit, as compared to the first embodiment. Therefore, it is very difficult to determine whether the data read as the cache data will be used thereafter. For example, as illustrated in FIG. 9, it is necessary to prepare the storage area of the buffer memory, even for incomplete data in the LBAn−3 to LBAn−1, or unused data in the LBAn+4 to LBAn+7 that exceeds the threshold value of the buffer memory. As described above, in the case of read cache process according to the comparative example, the read range CRc of the read head illustrated in FIG. 9 is larger than the read range CR1 in the first embodiment (CRc>CR1), and thus the useless range of the cache area of the buffer memory increases.

(2) It is possible to reduce the cache capacity of the buffer memory 90, and the occupied area of the buffer memory 90.

As described above, according to the storage system 1A according to the first embodiment, only when all values (data) V that correspond to a key K are readable, the data are stored in the buffer memory 90. Therefore, it is possible to reduce the cache capacity of the buffer memory 90, and it is also advantageous in that the occupied area of the buffer memory 90 can be reduced.

### First Modification Example

The operation of the storage system 1A according to a first modification example will be described. In this description, the configuration of the storage system 1A is substantially similar to that of the first embodiment, and thus detailed description thereof is not repeated.

### Operation

### Read (Read Cache) Process

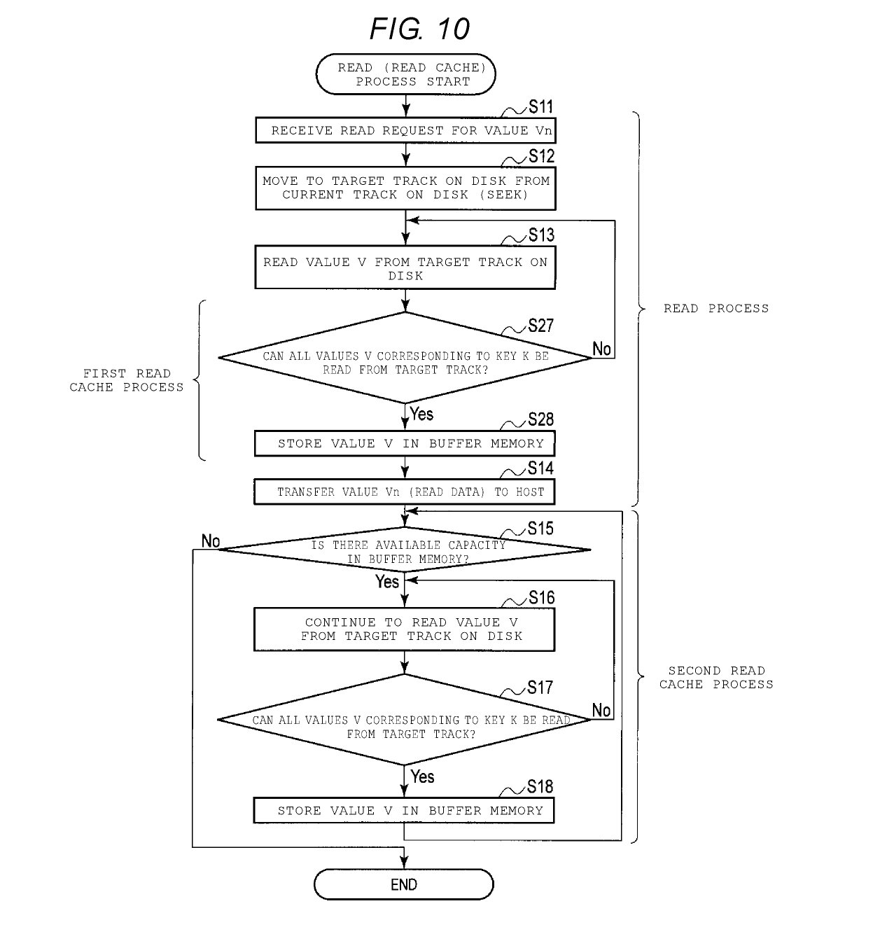

The read (read cache) process of the storage system 1A will be described with reference to FIGS. 10 to 13. In the first modification example, it is assumed that the position of the read head 15R after the seek precedes the position of the value Vn serving as the read data. In this case, it is possible to perform the read cache of the value ahead of the value Vn.

As illustrated in FIG. 10, the read and read cache process of the storage system 1A according to the first modification example is different from the first embodiment, in that a first read cache process (Step S27 and Step S28) is further performed.

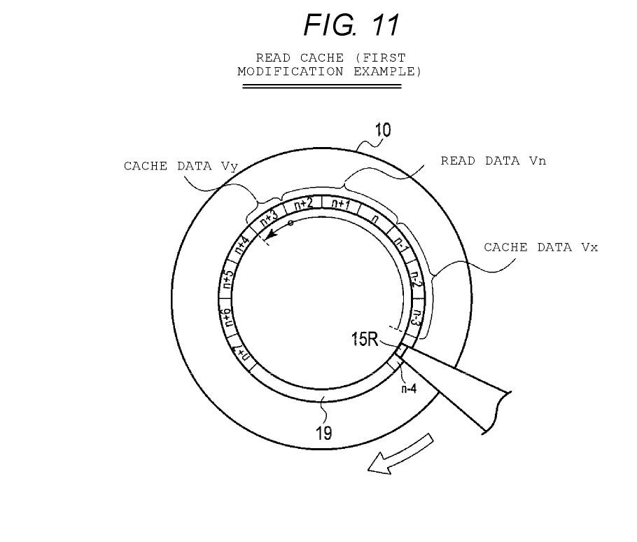

First, in Step S13, after the seek has been completed, the HDD1 reads the value V from the target track 19 of the disk 10. In the first modification example, as illustrated in FIG. 11, the position of the read head 15R after the seek precedes the position of the value Vn. In the present modification example, the MPU 60 of the HDD1 refers to the table T1, and reads the value Vx in the LBAn−3 to LBAn−1 from the target track 19 of the disk 10 by using the read head 15R.

In Step S27, the HDD1 refers to the key K of the value V which is read, and determines whether or not all of the value V corresponding to the referred key K can be read. More specifically, the CPU 55 of the HDD1 refers to the key management information 71 (FIG. 4) developed in the volatile memory 70, and determines whether or not all value Vx can be read, based on the information (first information) num indicating that the number of blocks of the value Vx corresponding to the key Kx. When the condition of Step S27 is not satisfied (No in S27), the HDD1 repeats the process of Step S27 until the value V relating to the read request is read.

In this case, as in the first modification example, when the first read cache process is started from the position illustrated in FIG. 11 (position that is in the middle of the LBAn−4 and ahead of the LBAn−3), the CPU 55 refers to the key management information 71, and determines that all of the value Vx (LBAn−3 to LBAn−1) can be read, based on the information (first information) num x indicating that the number of configuration blocks of the value Vx corresponding to the key Kx is “3”. This is because the number “3” of configuration blocks indicated by the information num x and the number “3” of blocks that can be read match (three blocks). Therefore, the CPU 55 can determine that all of the data which configures the value Vx can be read.

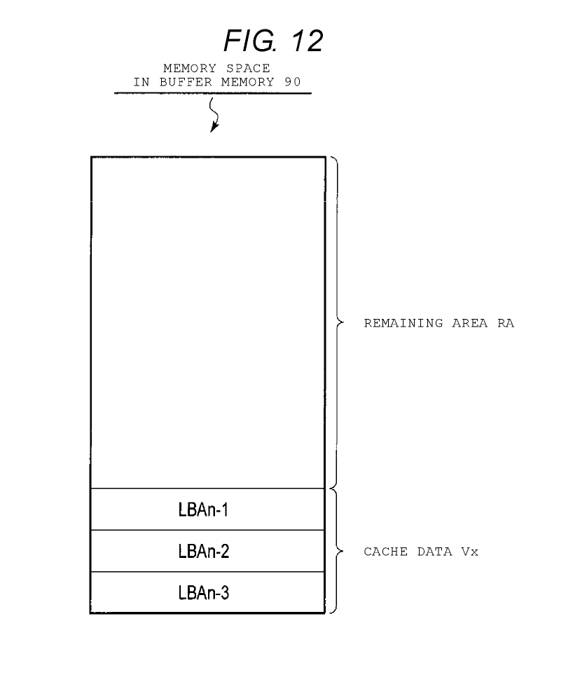

In Step S28, when the condition of Step S27 is satisfied (Yes in S27), the value V is stored in the buffer memory 90. As a result, for example, as illustrated in FIG. 12, the value Vx satisfying the condition of Step S27 (LBAn−3 to LBAn−1) can be stored in the buffer memory 90 as the cache data.

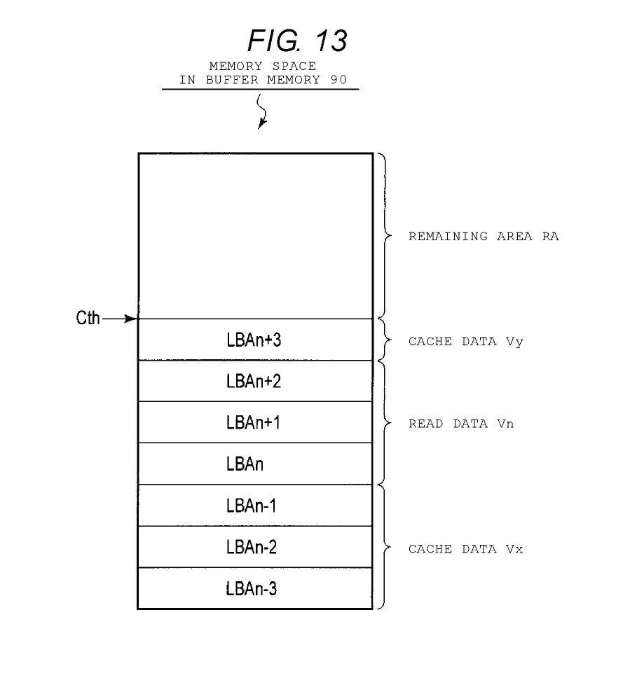

Thereafter, the storage system 1A performs a read process and a second read cache process (Step S15 to Step S18) similar to that in the first embodiment. As a result, in the first modification example, as illustrated in FIG. 13, it is possible to store the cache data Vx (LBAn−3 to LBAn−1) and the cache data Vy (LBAn+3) which are positioned ahead of and behind the value Vn (LBAn to LBAn+2) serving as the read data, in the buffer memory 90.

### Advantage

As described above, according to the configuration and operation of the storage system 1A according to the first modification example, at least the advantage (1) and (2) described above can be obtained. The storage system 1A according to the first modification example further executes the first read cache process (Steps S27 and S28) illustrated in FIG. 10.

Therefore, as illustrated in FIG. 13, it is possible to store the cache data Vx (LBAn−3 to LBAn−1) and the cache data Vy (LBAn+3) which are positioned ahead of and behind the value Vn (LBAn to LBAn+2) serving as the read data, in the buffer memory 90. As described above, the value Vx and the value Vy which are positioned ahead of and behind the value Vn serving as the read data, are stored in the buffer memory 90 as the cache data, and thus it is advantageous that hit rate can be further improved.

### Second Embodiment

A storage system 1B according to a second embodiment will be described. In this description, detailed description which is the same as those of the first embodiment is not repeated.

### Configuration

### Storage System

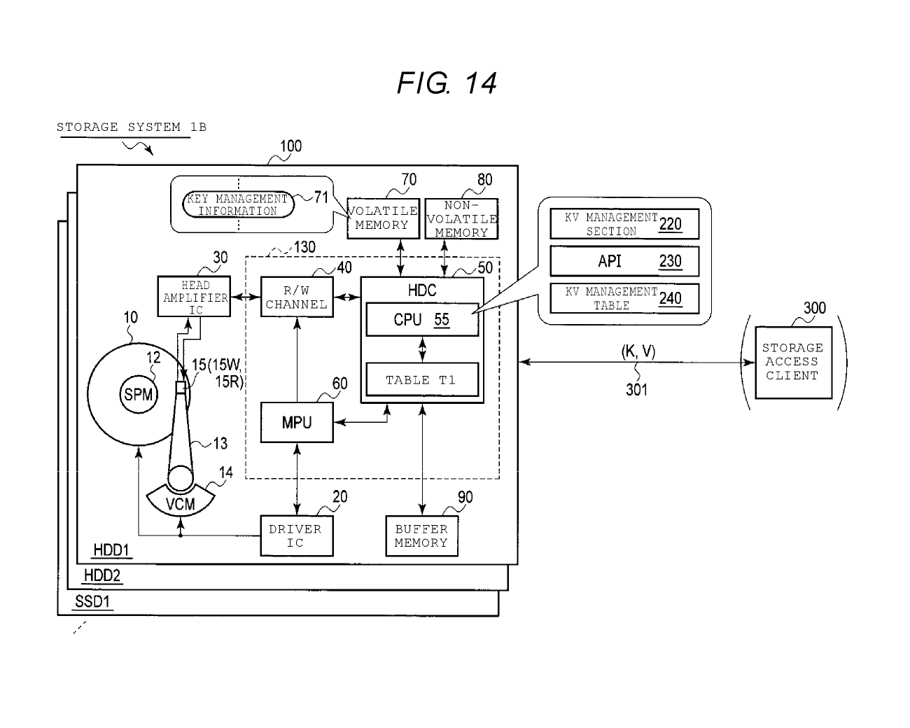

As illustrated in FIG. 14, the storage system 1B according to the second embodiment is different from the storage system 1A according to the first embodiment, in that the host (bridge unit) 200 is not included and the CPU 55 of the storage 100 includes the KV management section 220, the API 230, and the KV management table 240.

Since other configurations are substantially the same as that of the first embodiment, detailed description thereof is not repeated.

### Operation

### Read (Read Cache) Process

The read process and the read cache process of the storage system 1B according to the second embodiment are different from those according to the first embodiment, in that the processes performed by the host 200 (for example, S11 and the like in FIG. 5) are performed by the storage 100.

Since other operations are substantially the same as that of the first embodiment, detailed description thereof is not repeated.

### Advantage

As described above, according to the configuration and operation of the storage system 1B according to the second embodiment, at least the advantage (1) and (2) described above can be obtained. Further, the storage system 1B according to the second embodiment does not include the host (bridge unit) 200, and the CPU 55 of the storage 100 includes the KV management section 220, the API 230, and the KV management table 240.

Therefore, each storage 100 of the storage system 1B can be directly connected to the network 301. Accordingly, each storage 100 of the storage system 1B functions as each node of the storage system 1B, and can directly perform a part of communication with the client 300. As described above, it is possible to apply the storage system 1B as necessary.

### Third Embodiment

A storage system 1 according to a third embodiment will be described. Here, detailed description which is the same as those of the first and second embodiments is not repeated. Hereinafter, an outline of configuration of a KV-type storage system 1, PUT (write) operation, and GET (read) operation will be described.

### Configuration

### Storage System

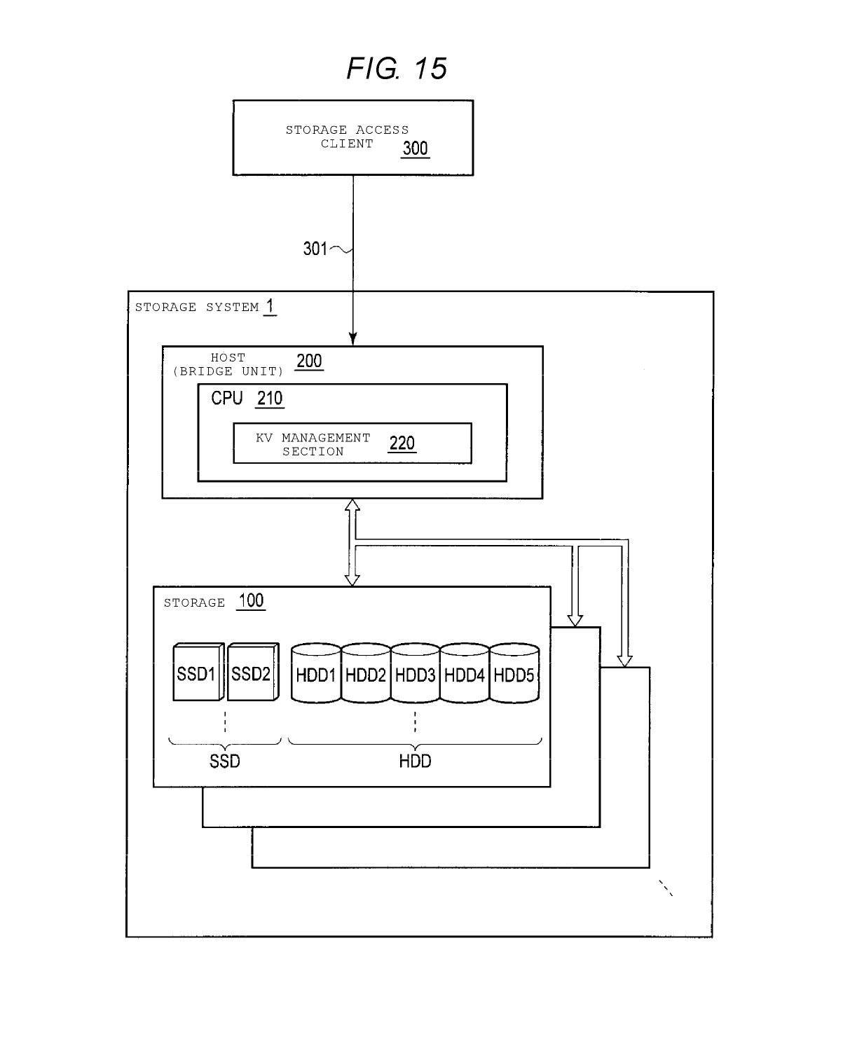

As illustrated in FIG. 15, the storage system 1 is configured to allow an access using the API from the external client 300 via the network 301 such as IP. The storage system 1 manages data transferred from the client 300 in units of data groups (object) including data V and an identifier K for identifying the data V. In the KV-type storage system, the identifier key K of any size, and the data V of any size associated with the key K are stored in the storage 100. According to the configuration, when the client 300 designates the key K, it is possible to PUT (write), GET (read), or DELETE (erase) the value V associated with the key K.

The storage system 1 further includes a plurality of storages 100 (SSD1, SSD2, HDD1, HDD2, HDD3, HDD4, HDD5), and manages the storages 100 by the KV management section 220.

The read speed VSSD of the SSD is faster than the read speed VHDD of the HDD (VSSD>VHDD). On the other hand, the data capacity CSSD of the SSD is smaller than the data capacity CHDD of the HDD (CSSD<CHDD). As described below, the storage system 1 performs operations by using the relationship based on the characteristics of the storage.

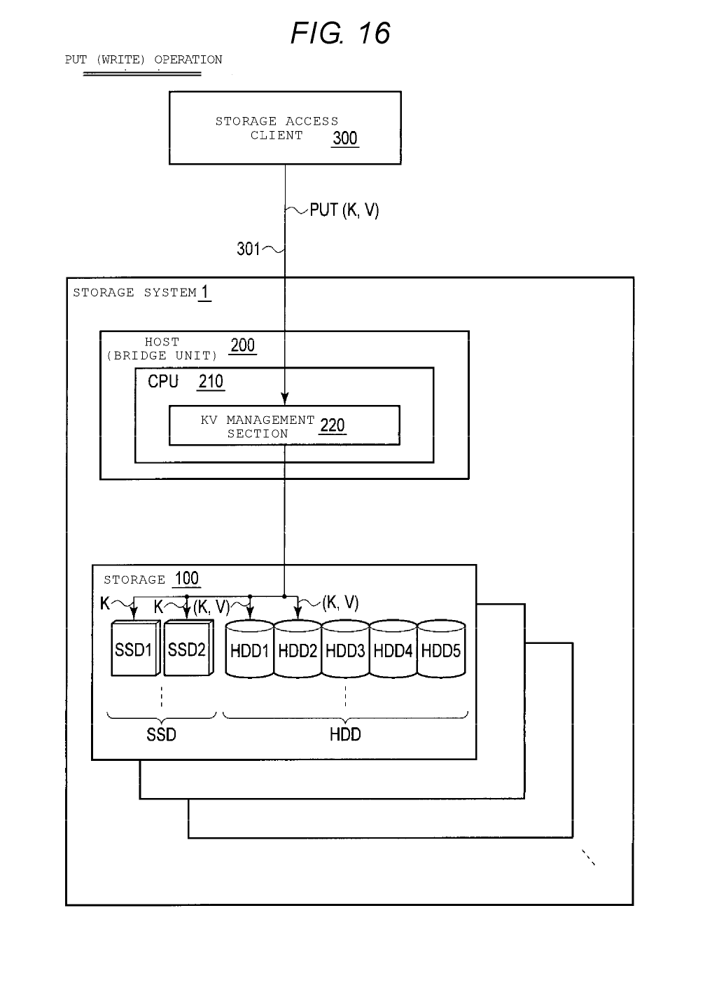

The configuration of the storage system 1 is not limited to the one illustrated in FIG. 16. For example, the storage system 1 may further include a management section that manages a key configuration indicating that which storage 100 stores the data V corresponding to the key K.

### Operation

### PUT (Write) Process

As illustrated in FIG. 16, when performing the PUT (write) process, the client 300 transmits a PUT (K, V) serving as a PUT request including a pair of the key K and the value V, to the host 200.

The KV management section 220 of the host 200 writes the key K in the SSD1 and the SSD2 based on the received PUT (K, V), and writes a set (K, V) of the key K and the value V in the HDD1 and the HDD2. In this way, the SSD1 and the SSD2 in which the same key K is stored, and the HDD1 and the HDD2 in which the same set (K, V) is stored may form a predetermined redundant array of independent (inexpensive) disks (RAID) group.

Subsequently, the KV management section 220 stores corresponding relationship between the key K and the set (K, V), and the storage (SSD1, SSD2, HDD1, HDD2) 100 in which the key K and the set (K, V) are stored, in the KV management table 240.

Subsequently, the KV management section 220 may respond, that the PUT process has been completed, to the client 300.

Through the above process, the set (K, V) relating to the PUT request is stored in the storage 100.

### GET (Read) Process

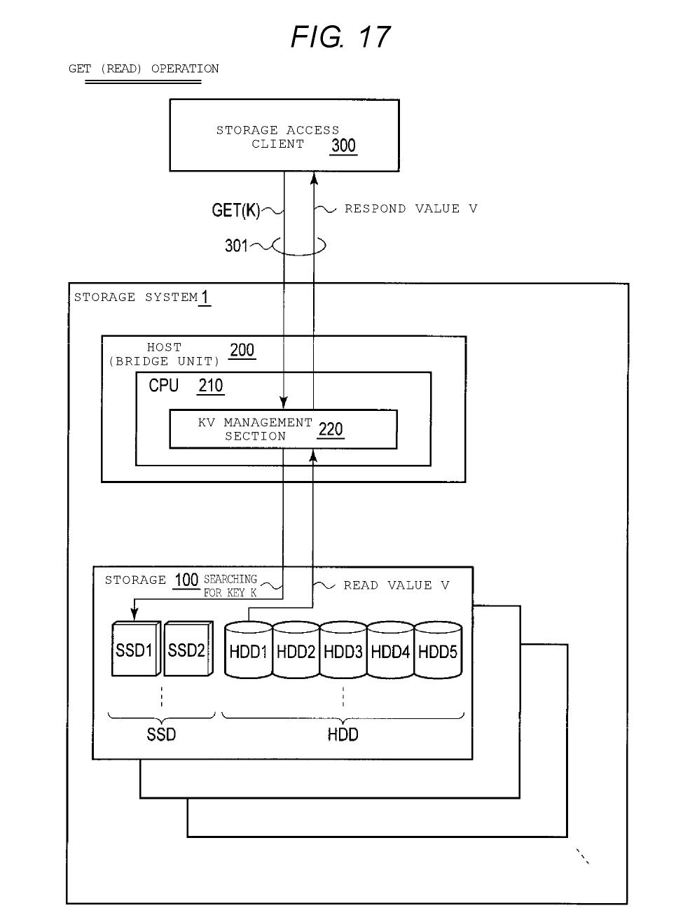

As illustrated in FIG. 17, when performing the GET (read) process, the client 300 transmits a key K (GET (K)) corresponding to the predetermined value V to the storage system 1 as a GET request.

The KV management section 220 that receives the key K refers to the KV management table 240 that indicates the relationship between the key K and the SSD to which the key K is written, obtains the key K, for example, by searching for the key K stored in the SSD1, and obtains, for example, an entry structure or the like serving as a structure of the key K.

Subsequently, the KV management section 220 reads the value V that is stored at the position indicated by pointer of the HDD1 which is included in the entry structure, from the HDD1 serving as the storage 100.

Subsequently, the KV management section 220 transmits the value V which is read to the client 300, and responds to the client 300.

When there are no hits even though the KV management section 220 searches for the key stored in the SSD1 and the SSD2, the KV management section 220 may return an error notice or a response that value V to be paired is not founded, to the client 300.

### Advantage

As described above, according to the configuration and operation of the storage system 1 according to the third embodiment, at least the advantage of (1) and (2) described above can be obtained.

Further, as described above, the storage system 1 according to the third embodiment can designate the key K with a variable length, and read and write the value V with a variable length. Therefore, it is possible to process unstructured data and simplify a software configuration.

The KV management section 220 of the host (bridge unit) 200 collectively manages the storages 100. Thus, even when configuring a large-scale storage, it is possible to reduce the number of management servers managing the storages 100, or to make the management servers be unnecessary. Therefore, the storage system 1 is advantageous for reducing total cost of ownership (TCO) and high performance.

The storage system 1 collectively controls various storages such as the SSD, the HDD, or the like having different response speeds and different capacities. Therefore, it is unnecessary to select the storage to match the processing purposes.

In addition, the storage system 1 can efficiently perform the PUT process and the GET process, by using the relationship between the read speed VSSD of the SSD and the read speed VHDD of the HDD (VSSD>VHDD), and the relationship between the data capacity CSSD of the SSD and the data capacity CHDD of the HDD (CSSD<CHDD). For example, in the PUT process, the KV management section 220 writes the value V of a large size in the HDD1 and the HDD2, and thus it is possible to satisfy the PUT request. For example, in the GET process, the KV management section 220 searches for the key K from the SSD1 and the SSD2 that have a fast read speed, and thus it is possible to satisfy the GET request within a predetermined response time of the client 300.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein maybe made without departing from the spirit of the inventions. The accompanying claims and their equivalents are intended to cover such forms or modifications as would fall within the scope and spirit of the inventions.

What is claimed is:

1. A storage device, comprising:
a disk including a plurality of tracks, each track including a plurality of addressable blocks of data;
a buffer memory; and
a controller that stores in the buffer memory, in response to a command to read a first value of a first key, the first value, and also a second value of a second key upon determining that the second value is entirely readable after the first value is read, from the same track as the first value.

2. The storage device according to claim 1, wherein the controller tracks for each of a plurality of keys, including the first key and the second key, one or more block addresses at which a value corresponding to the key is stored, including first block addresses for the first value and second block addresses for the second value.

3. The storage device according to claim 2, wherein the controller determines from the first and second block addresses that the second value is entirely readable after the first value is read, from the same track as the first value.

4. The storage device according to claim 1, wherein the controller does not store in the buffer memory, in response to the command to read the first value of the first key, a third value of a third key upon determining that the third value is not entirely readable after the first value is read, from the same track as the first value.

5. The storage device according to claim 4, wherein the third value is stored across two tracks.

6. The storage device according to claim 1, wherein the controller determines a remaining capacity of the buffer memory after storing the first value and the second value in the buffer memory, and does not store in the buffer memory, in response to the command to read the first value of the first key, a third value of a third key upon determining that the remaining capacity would become less than a threshold value as a result of storing the third value in the buffer memory.

7. The storage device according to claim 6, wherein the controller stores in the buffer memory, in response to the command to read the first value of the first key, a fourth value of a fourth key upon determining that the remaining capacity would not become less than the threshold value as a result of storing the fourth value in the buffer memory and the fourth value is entirely readable after the first value is read, from the same track as the first value.

8. A storage device, comprising:
a disk including a plurality of tracks, each track including a plurality of addressable blocks of data;
a buffer memory; and
a controller that stores in the buffer memory, in response to a command to read a first value of a first key, the first value, and also a second value of a second key upon determining that the second value is entirely readable from the same track as the first value and from a current read position on the disk until the first value is read.

9. The storage device according to claim 8, wherein the controller tracks for each of a plurality of keys, including the first key and the second key, one or more block addresses at which a value corresponding to the key is stored, including first block addresses for the first value and second block addresses for the second value.

10. The storage device according to claim 9, wherein the controller determines from the first and second block addresses that the second value is entirely readable before the first value is read, from the same track as the first value.

11. The storage device according to claim 8, wherein the controller does not store in the buffer memory, in response to the command to read the first value of the first key, a third value of a third key upon determining that the third value is not entirely readable from the same track as the first value.

12. The storage device according to claim 11, wherein the third value is stored across two tracks.

13. The storage device according to claim 8, wherein the controller determines a remaining capacity of the buffer memory after storing the first value and the second value in the buffer memory, and does not store in the buffer memory, in response to the command to read the first value of the first key, a third value of a third key upon determining that the remaining capacity would become less than a threshold value as a result of storing the third value in the buffer memory.

14. The storage device according to claim 13, wherein the controller stores in the buffer memory, in response to the command to read the first value of the first key, a fourth value of a fourth key upon determining that the remaining capacity would not become less than the threshold value as a result of storing the fourth value in the buffer memory and the fourth value is entirely readable from the same track as the first value.

15. A method for operating a storage device having a disk including a plurality of tracks, each track including a plurality of addressable blocks of data, and a buffer memory, the method comprising:
in response to a command to read a first value of a first key, storing in the buffer memory, the first value, and also a second value of a second key upon determining that the second value is entirely readable from the same track as the first value.

16. The method according to claim 15, further comprising:
tracking for each of a plurality of keys, including the first key and the second key, one or more block addresses at which a value corresponding to the key is stored, including first block addresses for the first value and second block addresses for the second value.

17. The method according to claim 16, further comprising:
determining from the first and second block addresses that the second value is entirely readable from the same track as the first value.

18. The method according to claim 15, further comprising:
determining that a third value of a third key is only partially readable from the same track as the first value, as a result of which the third value is not stored in the buffer memory in response to the command to read the first value of the first key.

19. The method according to claim 15, further comprising:
determining a remaining capacity of the buffer memory after storing the first value and the second value in the buffer memory; and
determining that the remaining capacity would become less than a threshold value as a result of storing a third value of a third key in the buffer memory, as a result of which the third value is not stored in the buffer memory in response to the command to read the first value of the first key.

20. The method according to claim 19, further comprising:
storing in the buffer memory, in response to the command to read the first value of the first key, a fourth value of a fourth key upon determining that the remaining capacity would not become less than the threshold value as a result of storing the fourth value in the buffer memory and the fourth value is entirely readable from the same track as the first value.
